(19) United States
(12) Patent Application Publication
(10) Pub. No.: US 2018/0173762 A1
(43) Pub. Date: Jun. 21, 2018

(54) System and Method of Adaptively Partitioning Data to Speed Up Join Queries on Distributed and Parallel Database Systems

(71) Applicant: Futurewei Technologies, Inc., Plano, TX (US)

(72) Inventors: Ron-Chung Hu, Palo Alto, CA (US); Guangyu Shi, Shenzhen (CN); Min Qiu, Fremont, CA (US); Masood Mortazavi, Santa Clara, CA (US); Jiafeng Zhu, Pleasanton, CA (US)

(21) Appl. No.: 15/380,647

(22) Filed: Dec. 15, 2016

(51) Int. Cl. G06F 17/30

(52) U.S. Cl. CPC G06F 17/30466; G06F 17/30457; G06F 17/30486; G06F 17/30477

(57) ABSTRACT

A method implemented by a database system, comprising generating, by a processor of the database system, a plurality of join requests to at least two database tables with a common field responsive to a plurality of data requests, identifying, by the processor, at least two intervals of data with the common field using the plurality of join requests, creating, by the processor, a shadow table comprising the at least two intervals of data with the common field, wherein the shadow table comprises a plurality of fields from the at least two database tables, and wherein the plurality of fields are identified based on at least one of the join requests, storing, in a memory coupled to the processor, the shadow table, and generating, by the processor, a response to a subsequent data request using data stored in the shadow table.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A database is a collection of information. A relational database is typically illustrated as one or more two-dimensional tables. Each table arranges items and attributes of the items in rows and columns. Each table row corresponds to an item (referred to as a record), and each table column corresponds to an attribute of the item (referred to as a field). In a relational database a collection of tables can be related to each other through a common attribute or “join key.” The common key enables information in one table to be automatically cross-referenced to corresponding information in another table.

To extract data from a relational table, queries according to a standard database-query language (e.g., Structured Query Language or SQL) can be used. Examples of SQL statements include INSERT, SELECT, UPDATE, and DELETE. The SELECT statement is used to retrieve information from the database and to organize information for presentation to the user or to an application program. The SELECT statement can also specify a join operation to join rows of multiple tables. A common type of join operation is a simple join (or equijoin), which uses an equal (=) comparison operator to join rows from multiple tables. Another type of join is a non-equijoin, which is based on operators other than the equal comparison (e.g., >, <, etc.).

### SUMMARY

In a parallel or distributed database system, tables are horizontally partitioned and stored across a plurality of network elements (NE). When an NE receives a query for data that is stored across multiple NEs, records associated with the queried data must be obtained, or shuffled, from all the NEs such that the queried data can be easily accessed and combined to properly respond to the query. This process of shuffling records across multiple NEs each time a query is received consumes a significant portion of a query response time. The concepts disclosed herein solve this problem by storing a copy of the records after being shuffled across the NEs in a shadow table such that the NE can use the copy of the records in the shadow table to resolve a query without having to shuffle the same records to answer subsequent queries. In addition, the copy of the records stored in the shadow table can be updated by adding new records as the new records are shuffled across the NEs. In this way, a NE stores at least one adaptable shadow table of records that are stored across the NEs to more efficiently provide responses to queries using the database system.

In an embodiment, the disclosure includes a method implemented by a database system, comprising generating, by a processor of the database system, a plurality of join requests to at least two database tables with a common field responsive to a plurality of data requests, identifying, by the processor, at least two intervals of data with the common field using the plurality of join requests, creating, by the processor, a shadow table comprising the at least two intervals of data with the common field, wherein the shadow table comprises a plurality of fields from the at least two database tables, and wherein the plurality of fields are identified based on at least one of the join requests, storing, by a memory coupled to the processor, the shadow table, and generating, by the processor, a response to a subsequent data request using data stored in the shadow table. In some embodiments, the disclosure further includes wherein the common field is a column in each of the at least two database tables that includes a common type of data, and/or wherein the plurality of fields included in the shadow table is selected based on at least one type of data indicated in at least one of the data requests, and/or wherein the at least two intervals of the common field comprise a first interval and a second interval, and wherein the first interval and the second interval are non-contiguous, and/or further comprising identifying, by the processor, cold data within the shadow table, and removing, by the processor, the cold data from the shadow table, and/or wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields, and/or further comprising updating, by the processor, the shadow table to further comprise a next interval of data with the common field responsive to another subsequent data request, and/or further comprising transmitting, by a transmitter coupled to the processor, metadata describing the at least two intervals and the fields of the shadow table to a master network element, wherein the master network element maintains a metadata table describing the shadow table stored at the network element, and/or wherein the at least two intervals of data are stored across a plurality of other network elements and across the at least two database tables.

In an embodiment, the disclosure includes a database system, comprising a memory, and a processor coupled to the memory and configured to generate a plurality of join requests to at least two database tables with a common field responsive to a plurality of data requests, identify at least two intervals of data with the common field using the plurality of join requests, create a shadow table comprising the at least two intervals of data with the common field, wherein the shadow table comprises a plurality of fields from the at least two database tables, wherein the plurality of fields are identified based on at least one of the join requests, and wherein the memory is configured to store the shadow table, and generate a response to a subsequent data request using data stored in the shadow table. In some embodiments, the disclosure further includes wherein the common field is a column in each of the at least two database tables that includes a common type of data, and/or wherein the fields included in the shadow table are selected based on at least one type of data indicated in at least one of the data requests, and/or wherein the processor is further configured remove cold data from the shadow table, and/or wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields.

In an embodiment, the disclosure includes an apparatus, comprising a memory, and a processor coupled to the memory and configured to generate a plurality of join requests to at least two database tables with a common field responsive to a plurality of data requests, identify at least two intervals of data with the common field using the plurality of join requests, create a shadow table comprising the at least two intervals of data with the common field, wherein the shadow table comprises a plurality of fields from the at least two database tables, wherein the plurality of fields are identified based on at least one of the join requests, and wherein the memory is configured to store the shadow table, and generate a response to a subsequent data request using data stored in the shadow table. In some embodiments, the disclosure further includes further comprising a transmitter coupled to the processor and configured to transmit metadata describing the at least two intervals and the fields of the shadow table to a master network element, wherein the master network element maintains a metadata table describing the shadow table stored at the network element, and/or wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields, and/or wherein the processor is further configured to update the shadow table to further comprise a next interval of data with the common field responsive to another subsequent join request, and/or wherein the at least two intervals of data are stored across a plurality of other network elements and across the at least two database tables, and/or wherein the common field is a column in each of the at least two database tables that includes a common type of data, and wherein the fields included in the shadow table are selected based on at least one type of data indicated in at least one of the data requests.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a database system.

FIG. 2 is a schematic diagram of an embodiment of a network element that stores and updates shadow tables of tables in the database system.

FIG. 3 is a schematic diagram illustrating an embodiment of tables distributed among multiple nodes of the database system.

FIG. 4 is an example of a query that requires a join operation to be performed on the tables of the database system.

FIG. 5 is a schematic diagram illustrating an embodiment of the tables distributed among the nodes of the database system after a shuffle operation is performed on the tables according to the sample query.

FIG. 6 is an example of an algorithm that manages metadata for a copy of the shadow tables at a node of the database system.

FIG. 7 is a diagram of an embodiment of storing and updating metadata for a copy of the shadow table at a node of the database system when a first case occurs.

FIG. 8 is a diagram of an embodiment of storing and updating metadata for a copy of the shadow table at a node of the database system when a second case occurs.

FIG. 9 is a diagram of an embodiment of storing and updating metadata for a copy of the shadow table at a node of the database system when a third case occurs.

FIG. 10 is a diagram of an embodiment of storing and updating metadata for a copy of the shadow table at a node of the database system when a fourth case occurs.

FIG. 11 is a diagram of an embodiment of storing and updating metadata for a copy of the shadow table at a node of the database system when a fifth case occurs.

FIG. 12 is a diagram of an embodiment of storing and updating metadata for a copy of the shadow table at a node of the database system when a sixth case occurs.

FIG. 13 is a flowchart of an embodiment of a method of storing and updating a shadow table of records.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

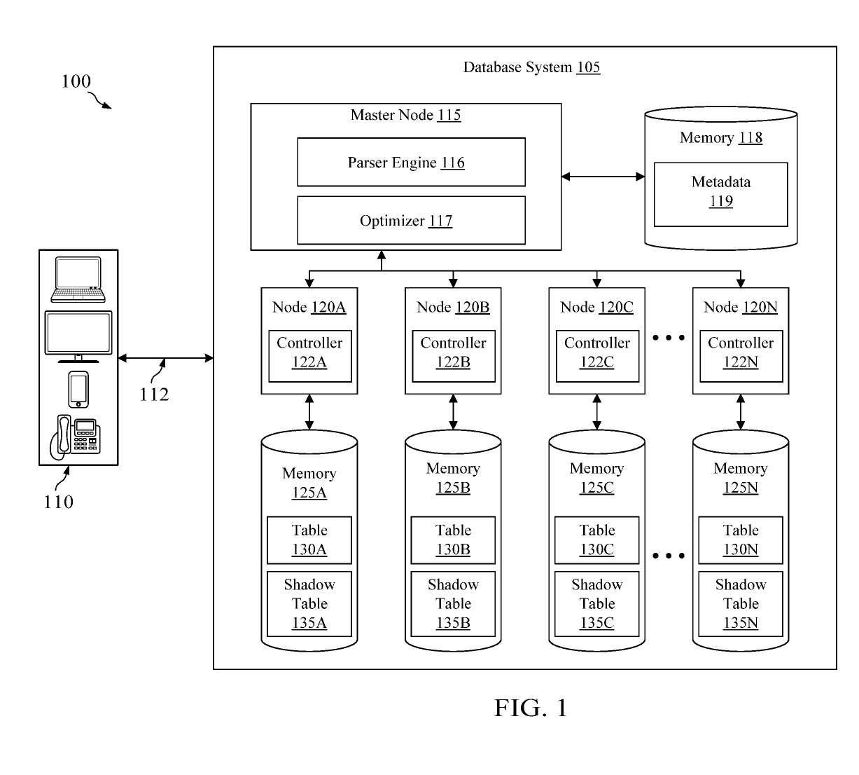

FIG. 1 shows database network 100 including a database system 105 that is accessible by one or more client terminals 110. The client terminal 110 is coupled to the database system 105 over a link 112. As examples, the link 112 may be a local area network (LAN), wide area network (WAN), or other type of communications channel. From the client 110, a user or software application is able to issue database queries to extract data stored in the database system 105. Such queries are according to SQL from the American National Standards Institute (ANSI), but other query languages and techniques may be used.

The database system 105 includes a master node 115 and a plurality of nodes 120A-N. The master node 115 is configured to control and manage nodes 120A-N. The master node 115 may include a parser engine 116, an optimizer 117, and a memory 118. The memory 118 may comprise metadata 119. The parser engine 116 may be implemented in software, hardware, and/or firmware and may be configured to receive an SQL statement from a client application executed at the client 110. In an embodiment, parser engine 116 is further configured to interpret a query, such as an SQL statement, check for proper SQL syntax, and send out executable steps to be performed by the respective controllers 122A-N of the nodes 120A-N. The optimizer 117 may be implemented in software, hardware, and/or firmware and may be configured to remove columns that are inapplicable or unnecessary to be stored with the shadow tables 135A-N. The metadata 119 may be metadata that describes the shadow tables 135A-N stored in the memory 118. In some embodiments, the metadata includes a primary key column of the shadow table, a primary key range covered by the shadow table, a list of primary keys that are covered by the shadow table, row identifiers (IDs) of the records covered by the shadow table, and/or relevant columns referenced in the queries. A primary key column may refer to a column by which the records of the table are organized. For example, the primary key column is the left most column of the table. A primary key may refer to a value within the primary key column or a value associated with the type of data stored in the primary key column. A primary key column and/or primary key may also refer to a row identifier defined by default when a table is not configured to with a specific primary key column and/or primary key. A primary key range may refer to a range of values included in the primary key column. As should be appreciated, the metadata may further include any additional information that describes the shadow table. In an embodiment, the memory 118 storing metadata 119 is a cache, allowing for quick access of the metadata.

In one embodiment, each node 120A-N includes the controller 122A-N. The controllers 122A-N are configured to communicate with each other and the parser engine 116, optimizer 117, and/or memory 118 of the master node 115. Each controller 122A-N is responsible for managing access of a respective portion of the database. Each controller 122A-N may be implemented in software, hardware, and/or firmware and configured to manage access (including reads and writes) of data stored in each of the respective memories 125A-N of the database system 105. In some embodiments, the controllers 120A-N are configured to manage the creation and modification of the tables 130A-N in the database system 105. To enable parallel processing, each table in the database system 105 is divided into a plurality of table partitions 130A-N and distributed among each of the controllers 120A-N. As shown in FIG. 1, the table portions 130A-N are stored in respective memories 125A-N. A database typically includes a large number of tables for storing data, each of tables being organized by a primary key column or a default row identifier (ID). In one embodiment, rows of each table are distributed among the controllers 120A-N and the memories 125A-N based on a primary key of the table. A primary key can be defined to include a single column or a combination of columns. For example, a primary key column may be the column of the table by which the remainder of the table is organized. For a given row, a value in a primary key column of a record is passed through a hashing or modular algorithm, with the output of the hashing or modular algorithm producing an indication of which controller 120A-N and/or memories 125A-N the given row is to be stored in. For example, a result of a modular operation on primary key of a record indicates the node at which the record will be stored.

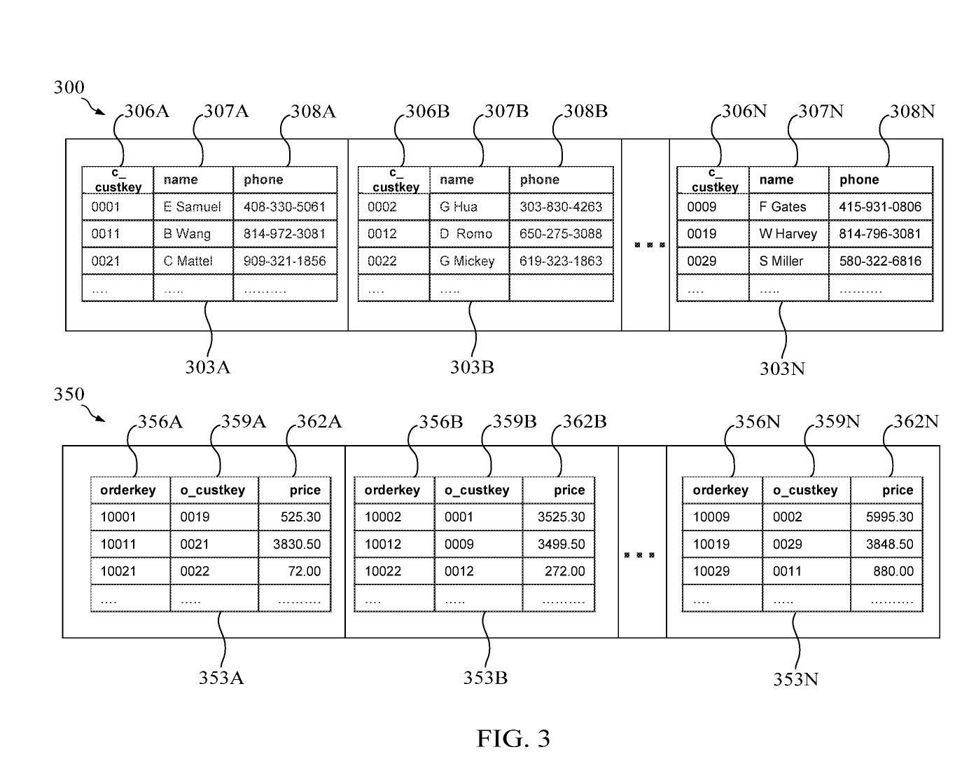

The database system 105 responds to a data request, such as an SQL query, by accessing the partitioned tables 130A-N. For example, an SQL query 400 may indicate a join column, or common field, in two or more tables partitioned across the nodes 120A-N by which the records need to be shuffled, or accessed and re-organized such that each of the nodes 120A-N stores the same values in the join column of the tables indicated by the SQL query, as will be further described below with reference to FIGS. 3-5. In an embodiment, the join column, or common field, is a column in each of the two or more tables that includes a common type of data. In an embodiment, responding to the SQL query 400 may require access to at least two non-contiguous intervals of data within the join column The intervals of data may be stored in different ones of the partitioned tables 130A-N and at different memories 125A-N. The time to shuffle the records at run time consumes a significant portion of query response time. Due to the distributed nature of the data, the time to shuffle the records at run time may consume up to 90 percent (%) of the query response time.

Disclosed herein are embodiments to save copies of the shuffled records and store them as the shadow tables 135A-N in the memories 125A-N of the database system 105. In an embodiment, a shadow table 135A-N includes the records that are accessed and aggregated after a shuffle operation is performed in response to a query. The shadow tables 135 A-N may be stored by the node 120A-N that performs the shuffle operation as a table in memories 125A-N. In an embodiment, the parameters of the shadow table 135A-N are stored in the metadata 119 at the master node 115. For example, the intervals of records that are stored in the shadow tables 135A-N are stored as parameters in the metadata 119. In this way, when the parser engine 116 receives a SQL query, the parser engine 116 accesses the metadata 119 to determine whether a copy of the records necessary to respond to the request is already stored at one of the shadow tables 135A-N. If the records necessary to respond to the request are stored in one of the shadow tables 135A-N, then the parser engine 116 instructs the controllers 122A-N of the appropriate node 120A-N to access the pertinent shadow table 135A-N to generate a response to the query. If the records necessary to respond to the request are not stored in any of the shadow tables 135A-N, then the parser engine 116 instructs the controllers 112A-N to perform a shuffle operation on the tables 130A-N. In an embodiment, the join column included in the SQL query may be the primary key column for the tables that need to be accessed to respond to the query. In such an embodiment, the shuffle operation may not need to be performed since all tables stored at the node are organized to include the same primary key values. In one embodiment, the controllers 112A-N aggregates the records with attributes after the shuffle operation is performed according to a primary key. In an embodiment, the controllers 112A-N adds the records and attributes to an existing shadow table 135A-N of the primary key. In an embodiment, the controllers 112A-N generate a new shadow table 135A-N for the primary key when a shadow table 135A-N is not already generated for the primary key.

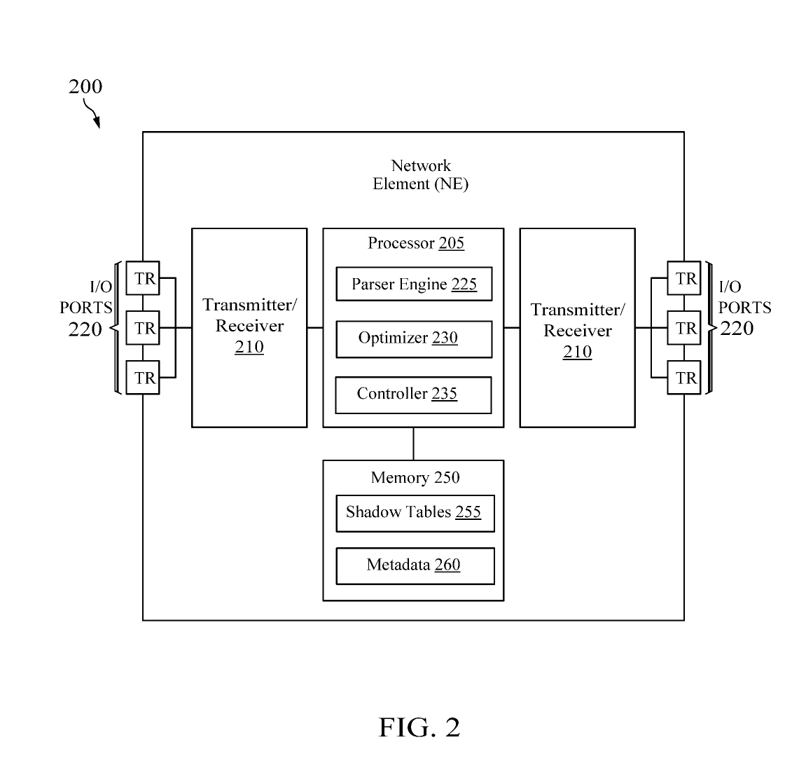

FIG. 2 is a schematic diagram of an embodiment of an NE 200, such as database system 105 or nodes 120A-N in a network such as the database network 100. NE 200 may be configured to implement and/or support the storing and updating of copies of shadow table mechanisms and schemes described herein. NE 200 may be implemented in a single node or the functionality of NE 200 may be implemented in a plurality of nodes. One skilled in the art will recognize that the term NE encompasses a broad range of devices of which 200 is merely an example. NE 200 is included for purposes of clarity of discussion, but is in no way meant to limit the application of the present disclosure to a particular NE embodiment or class of NE embodiments.

At least some of the features/methods described in the disclosure are implemented in a network apparatus or component such as an NE 200. For instance, the features/methods in the disclosure may be implemented using hardware, firmware, and/or software installed to run on hardware. The NE 200 is any device that transports packets through a network, e.g., a switch, router, bridge, server, a client, etc. As shown in FIG. 2, the NE 200 comprises transceivers (Tx/Rx) 210, which may be transmitters, receivers, or combinations thereof. The Tx/Rx 210 is coupled to a plurality of ports 220 for transmitting and/or receiving frames from other nodes.

A processor 205 is coupled to each Tx/Rx 210 to process the frames and/or determine which nodes to send the frames to. The processor 205 may comprise one or more multi-core processors and/or memory devices 250, which may function as data stores, buffers, etc. The processor 205 may be implemented as a general processor or may be part of one or more application specific integrated circuits (ASICs) and/or digital signal processors (DSPs).

The processor 205 comprises a parser engine 225, an optimizer 230, a controller 235, and may comprise means to implement the functional steps in method 1300, as discussed more fully below, and/or any other flowcharts, schemes, and methods discussed herein. In an embodiment, the parser engine 225 is similar to parser engine 116, the optimizer 230 is similar to optimizer 117, and the controller 235 is similar to controllers 122A-N. As such, the inclusion of the parser engine 225, optimizer 230, controller 235 and associated methods and systems provide improvements to the functionality of the NE 200. Further, the parser engine 225, optimizer 230, and controller 235 effects a transformation of a particular article (e.g., the network) to a different state. In an alternative embodiment, the parser engine 225, optimizer 230, and controller 235 may be implemented as instructions stored in the memory device 250, which may be executed by the processor 205.

The memory device 250 may comprise a cache for temporarily storing content, e.g., a random-access memory (RAM). Additionally, the memory device 250 may comprise a long-term storage for storing content relatively longer, for example, a read-only memory (ROM). For instance, the cache and the long-term storage may include dynamic RAMs (DRAMs), solid-state drives (SSDs), hard disks, or combinations thereof. The memory device 250 may be configured to store shadow tables 255 and metadata 260, as discussed more fully below. In an embodiment, the shadow tables 255 may be similar to shadow tables 135A-N, and the metadata 260 may be similar to metadata 119.

It is understood that by programming and/or loading executable instructions onto the NE 200, at least one of the processor 205 and/or memory device 250 are changed, transforming the NE 200 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions (e.g., a computer program product stored in a non-transitory medium/memory) may be viewed as a particular machine or apparatus.

FIG. 3 is a schematic diagram illustrating an embodiment of to-be shuffled tables 300 and 350 distributed among multiple nodes (e.g., nodes 120A-N) of the database system (e.g., database system 105). Table 300 shows a subset of columns of a customer table. Customer table 300 includes columns for a customer key (c_custkey column 306A-N), name (name column 307A-N), and phone number (phone column 308A-N). The customer table 300 stores a large content of information related to customers. The customer table 300 is partitioned into N partitions 303A-N, in which a portion of the information of the customer table 300 is stored in each partition 303A-N. For example, the portion of the customer table 300 for each partition 303A-N may be respectively stored in each of the tables 130A-N. For example, partition 303A of customer table 300 is stored in table 130A; partition 303B of customer table 300 is stored in table 130B, etc. The information stored in the partitions 303A-N is based on a modular or hash function of the c_custkey column 306A-N, which is the primary key column for the customer table 300. For example, the value of the attributes in c_custkey column 306A-N is divided by the number of nodes, and then a remainder of that division operation is a value identifying which node to store that record in. The remainder of the division may also identify the memory corresponding to a node in a database system to store the information as a table. The nodes may be similar to the nodes 120A-N of the database system 105.

Table 350 is similar to table 300, except that table 350 shows a subset of columns of an orders table. The orders table 350 includes columns for an order key (orderkey column 356A-N), customer key (o_custkey column 359A-N), and price (price column 362A-N). The orders table 350 is also partitioned into N partitions 353A-N based on the number of nodes, or memories corresponding to the nodes, available in the database system. The partitions 353A-N are to-be tables that organize information based on a modular or hash function of the attributes in the orderkey column 356A-N, which is the primary key column for the orders table 350.

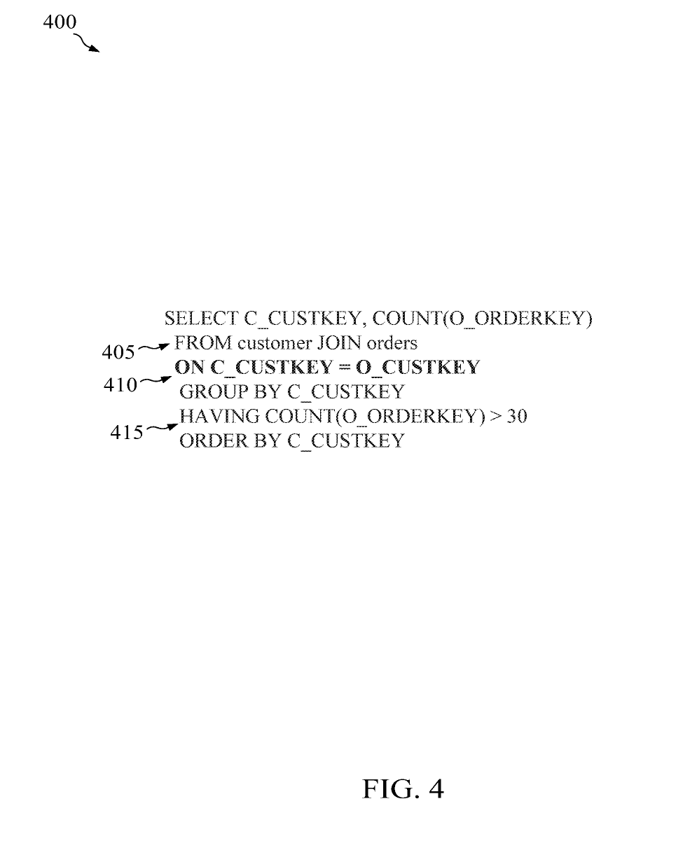

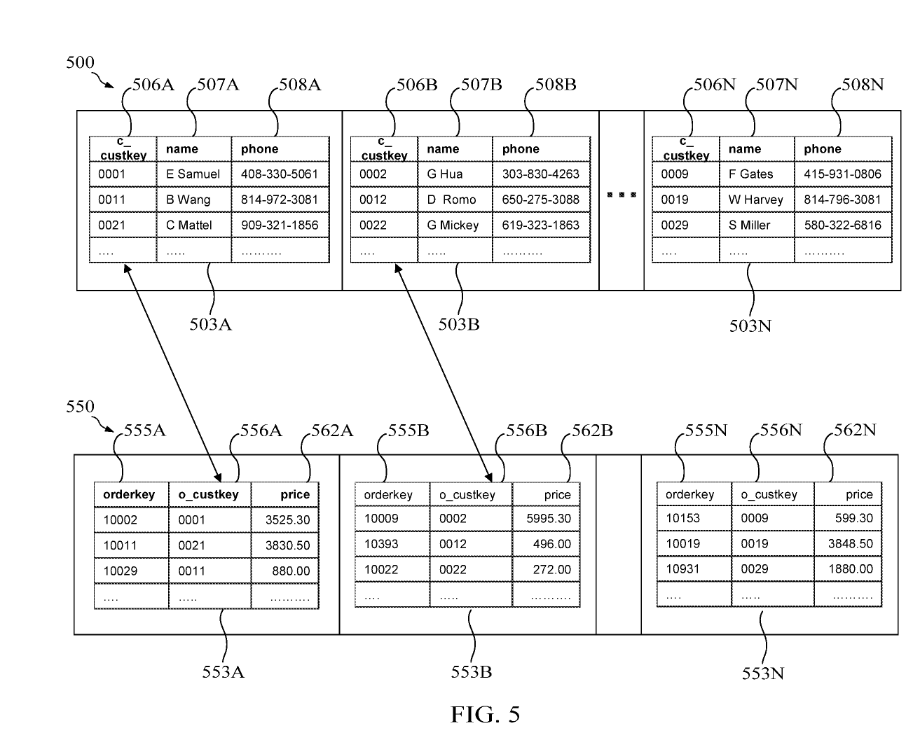

FIG. 4 shows example of a query 400 that requests a join operation to be performed on the tables (e.g., tables portions 130A-N) of the database system (e.g., database system 105). The query 400 shown in FIG. 4 is an example of a query that results in the shuffling of tables 300 and 350 shown in FIG. 3 to generate shadow tables 500 and 550 shown in FIG. 5. However, as should be appreciated, any SQL query including a join condition for tables that are partitioned across multiple nodes can be used to initiate generation of a shadow table. The query 400 may also be referred to herein as a data request.

In an embodiment, the parser engines 116 or 225 of the master node 115 receives the query 400 when an application executed by the client 110 sends the query to the database system 105. For example, a data analyst or a web application executed by the client sends the query to the database system. Query 400 is an SQL request for data regarding customers who have made more than 30 orders and show the total number of all of their orders. Line 405 of query 400 instructs that a join operation be performed on the customer table, such as customer table 300 of FIG. 3, and the orders table, such as orders table 350 of FIG. 3. In this way, line 405 of query 400 includes identifiers of the tables to be joined.

Query 400 also includes an indication of a common field, which is a column in each of the tables that are to be joined that includes a common type of data. For example, a common field is a join column. Line 410 indicates the join columns to use when shuffling and then joining the tables. Specifically, line 410 indicates the join columns (c_custkey and o_custkey) in the tables that need to be accessed (e.g., shuffled) and re-organized such that the values in the c_custkey column of the customer table 300 match up with the values in the o_custkey column of the orders table 350 at each of the nodes (e.g., nodes 120A-N). The join column may be a column of the customer table 300 that includes attributes common to or includes attributes associated with a common category of data as a column of the orders table 350. In this way, the customer table 300 and the orders table 350 can be joined according to the join columns with common types of data. Line 415 indicates that the query is for a count of the customers who have made more than 30 orders. The queried interval for the query 400 includes the primary key values for the customers who have made more than 30 orders. Therefore, query 400 instructs a parser, such as parser engines 116 or 225, to perform a shuffle and join operation across partitions of the customer table and the orders table to identify the customers who have made more than 30 orders.

In an embodiment, the parser identifies at least two intervals of data from the customer table and the orders table. The data describes data requested by query 400. For example, the parser identifies customers with customer identifiers 1-10 and 15-20 that have made more than 30 orders. The two intervals of data are the data regarding orders made by customers with customer identifiers 1-20 and are the data regarding orders made by customers with customer identifiers 10-15. In an embodiment, the data associated with customer identifiers 1-20 and customer identifiers 10-15 are stored in a shadow table.

In an embodiment, a data request comprises an identifier of at least two database tables, a common field, a requested interval of data, and/or a plurality of other fields that should be included in the shadow table. The data request instructs a processor, or controller 122A-N, to join the first table and the second table according to the common field in both tables for access to the interval of data. The interval of data comprises the records that are needed to answer the queries. The records may be stored across a plurality of different nodes. The records may be shuffled at one of the nodes and saved as a shadow table such that the next time a query is received for at least a portion of the interval of data, the node can use the shadow table instead of having to shuffle the records again.

The processor also obtains data from the other fields, as indicated by the data request, from the first and second table. The data in the other fields are associated with the data requested by the data request. The other fields are columns in the first table and the second table associated with the records that need to be accessed to answer the data request and should be stored in the shadow table. The data included in the other fields of both tables may be obtained and added to the records of the shadow table.

FIG. 5 is a schematic diagram illustrating an embodiment of a shadow customer table 500 and a shadow orders table 550 distributed among the nodes of the database system after a shuffle operation is performed on the orders table 350 according to the sample query 400. In an embodiment, the nodes may be similar to nodes 120A-N, and the database system may be similar to database system 105. As shown in FIG. 5, the customer table 500 remains unchanged relative to customer table 300. Customer table 500 also includes columns for a customer key (c_custkey column 506A-N), name (name column 507A-N), and phone number (phone column 508A-N). The tables 503A-N of partitioned customer table 500 continue to store the same tables across all the nodes, and tables 503A-N are still ordered according to the columns c_custkey 506A-N, which is the primary key column. The shadow customer table 500 is the same as customer table 300 because customer table 300 did not need to be shuffled to respond to the query 400. Customer table 300 did not need to be shuffled because query 400 included an indication that the join column for the customer table 300 is the c_custkey columns 306A-N, which is the primary key column of the customer table 300. When the join column in a query is the same as the primary key column of a table, the table does not need to be shuffled across the nodes.

In contrast, the orders table 350 does need to be shuffled to respond to query 400 because the join column for the orders table 350 and the primary key column for the orders table 350 are different. The join column for the orders table 350 is the o_custkey column 359A-N and the primary key column for the orders table 350 is the orderkey column 356A-N. Because the join column o_custkey 359A-N indicated by query 400 is different than the primary key column orderkey 356A-N, the orders table 350 needs to shuffled, or access and re-organized such that the values in the join column o_custkey 556A-N are the same as the values in the c_custkey column 506A-N. In this way, orders table 550 is organized similar to orders table 350, but includes different values in the join column (o_custkey column 556A-N). The orders table 550 includes columns for an order key (orderkey column 555A-N), customer key (o_custkey column 356A-N), and price (price column 562A-N).

Each partition of the tables stores the same values in the join column after shuffling has been performed. For example, in a first partition of the customer table 503A, the c_custkey column 506A contains the values 0001, 0011, and 0021. Similarly, in a first partition of the orders table 553A, the o_custkey column 556A also contains the values 0001, 0021, and 0011. The first partition of the customer table 503A and first partition of the orders table 553A are both stored on a first node of the database system. In the second partition of the customer table 503B, the c_custkey column 506B contains the values 0002, 0012, and 0022. Similarly, in the second partition of orders table 553B, the o_custkey column 556B also contains the values 0002, 0012, and 0022. The second partition of the customer table 503B and second partition of the orders table 553B are both stored on a second node of the database system. In the Nth partition of the customer table 503N, the c_custkey column 506N contains the values 0009, 0019, and 0029. Similarly, in the Nth partition of orders table 553N, the o_custkey column 556N also contains the values 0009, 0019, and 0029. The Nth partition of the customer table 503N and Nth partition of the orders table 553N are both stored on a Nth node of the database system. In this way, the shuffle operation generates a new shadow table that comprising a re-organization of information that is stored at multiple nodes in the database system.

The shuffle operation is performed after a data request is received but before the join operation is performed on a common field, such as a join column, specified by the data request. The data request (e.g., query 400) includes at least one join condition to specify criteria to select records from two or more tables stored at a node. During a shuffle operation for a table with a primary key column different from the join column, the records are shuffled based on a hash value of the join column. For example, orders table (e.g., orders table 350) records are shuffled based on the values of o_custkey column 359A-N (join column). The embodiments disclosed here generate a shadow table comprising the records of the orders table that have been shuffled based on the values of the o_custkey column 359A-N. The shadow table should include the primary key column (or RowID if a primary key is not present) if the primary key column is not referenced in the data request. The system later joins the values in the c_custkey columns 506A-N of customer table 500 with the values in the o_custkey column 556A-N of orders table 550 based on the query in FIG. 4. In this way, each node in the database system constructs one or more shadow tables having the same values in the column that is the common field of the tables.

According to some embodiments, the node may be configured to store the shadow table in a memory of the node. For example, nodes 120A-N are configured to store a shadow table in shadow tables 135A-N in the respective memory 125A-N. The node may also be configured to store metadata describing the contents of the shadow table in a metadata server of a master node of the database system. For example, nodes 120A-N are configured to store metadata describing the shadow table metadata server 119 of memory 118 corresponding to the master node 115. In some embodiments, the metadata includes a primary key column, primary key range, a list of primary keys that are included in the shadow table, a row ID of the shadow table, and/or relevant columns referenced in the queries. As should be appreciated, the metadata may further include any additional information that describes the shadow table.

In some embodiments, the node is configured to determine whether a shadow table according to a primary key already exists in a memory of a node. For example, the controllers 122A-N or 235 use the metadata 119 or 260 to determine whether a shadow table according to a specified key already exists in a memory of the nodes 120A-N. If such a shadow table already exists, then the node may be configured to access the shadow table to respond to a query instead of re-shuffling the same tables to generate the shadow table again. If only a portion of the attributes for a primary key column are saved in the shadow table, the node may be configured to shuffle to the records for the remaining keys that are needed. For example, the remaining keys that are needed may be shuffled according to row ID. Once the remaining keys have been shuffled to generate another shadow table, those shuffled records may be added to or merged into the existing but incomplete shadow table.

In some embodiments, the shadow table is filtered before the shadow table is stored at the node. In an embodiment, the shadow table only includes records relevant to answer a query. In some embodiments, the node is configured to remove records from a shadow table before storing the shadow table. For example, cold data included as values in the shadow table is removed. Cold data refers to data that has not been accessed, added, or edited within a certain period of time. For example, the controller (e.g., controller 122A-N) identifies whether records in the shadow tables comprise cold data based on whether the records have been accessed, added, or edited within a certain period of time. The controller is configured to remove records in the shadow table that comprise cold data. In addition, data that is irrelevant to a current query or popular queries may be removed from the shadow table before being stored.

In some embodiments, the filtering of the table is performed before shuffling the table and storing a copy of the shadow table. In an embodiment, the node identifies other fields (columns of the table) that are relevant in responding to the query, and the node is configured to only shuffle those fields that are relevant to the query plus the primary key column (or RowID if a primary key column is not present). The fields that are relevant to the query are indicated in the data request. The primary key column is always included in the shuffling in order to properly identify the individual records to be included in the shadow table. In this way, the node does not perform a shuffle operation on the columns that are irrelevant or unnecessary. In an embodiment, the node does not obtain cold data from the tables while shuffling records even if the cold data is relevant to responding to the data request. The cold data may not be included in the shadow table. In this way, only pertinent data is stored in the shadow tables to save resources.

According to some embodiments, the storing of the shadow tables of the tables is adaptable and efficient in the sense that only one table is stored for a primary key or primary key column. As records are identified and shuffled for primary key values that are not stored in the shadow table, those records can be added to the existing shadow table of the table without the need to create a new shadow table for the same primary key column. In the same way, irrelevant or unnecessary columns may be removed from the shadow table before storage to prevent wasting unnecessary storage space in the database system.

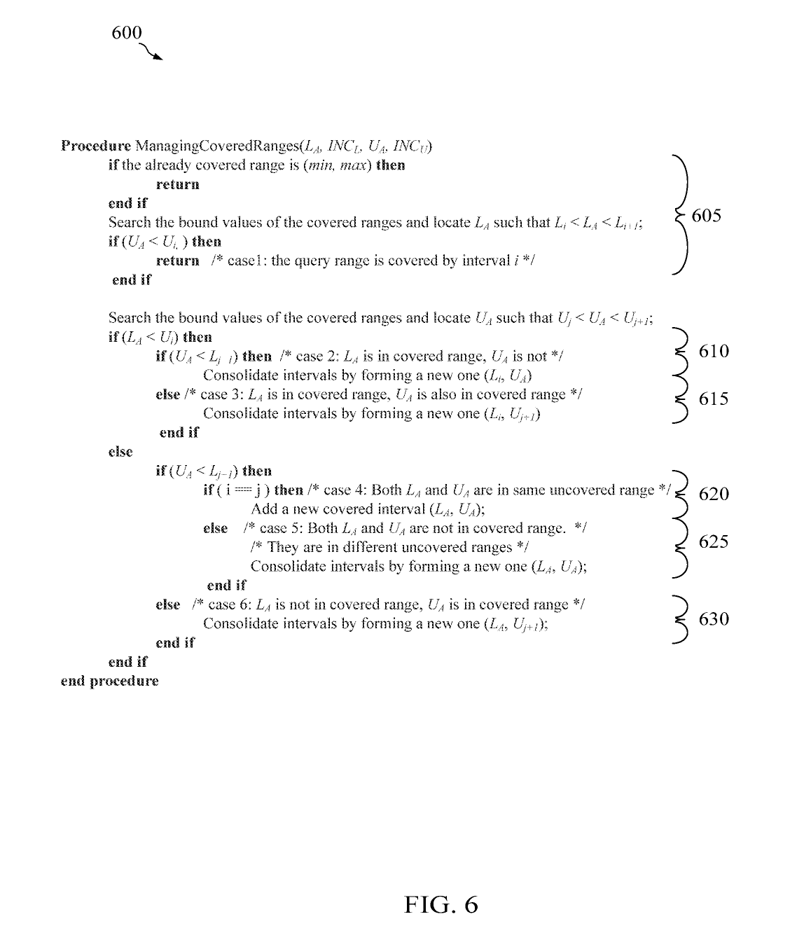

FIG. 6 is an example of an algorithm 600 that manages metadata for a copy of the shadow tables at a node of the database system. In an embodiment, the nodes of the database system may be similar to the nodes 120A-N of the database system 105. In an embodiment, the controller 122A-N or 235 is configured to implement the algorithm 600 when creating or updating a shadow table of a table. The shadow table of the table may be similar to the shadow tables 135A-N or 255. In algorithm 600, the queried interval is indicated as L_{A}<A<U_{A}, in which L_{A} is the lower value and U_{A} is the upper value of the queried interval. In algorithm 600, INC_{U} indicates whether L_{A} or U_{A} is inclusive or not. The common field is the column in the relevant tables that stores values associated with A. In algorithm 600, min represents the minimum possible primary key value of a column, and max represents the maximal possible primary key value of a column. In algorithm 600, Lᵢ is the lower bound and Uᵢ is the upper bound for the primary key interval i.

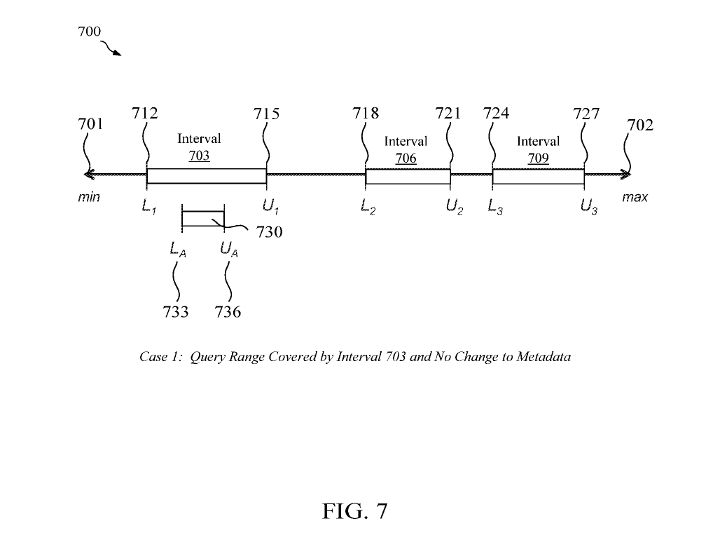

Section 605 of algorithm 600 shows an example of how the database system handles case 1. Case 1 occurs when the database system processes a query for data within a queried interval that is included in a shadow table stored at the nodes. The queried interval includes one or more primary key values or row IDs that should be included in the shadow table for the database system to provide a response to the query. In an embodiment, the primary key values are certain specified attributes in a primary key column of a primary table in a database system. The shadow table may include certain intervals that were previously stored. The intervals stored in the shadow table may be primary key ranges, row ID ranges, a list of specific primary keys, or a list of specific row IDs. The intervals in the shadow table and the queried interval are further described in FIG. 7. As delineated in section 605, if the queried interval is in the covered range of the shadow table, the node searches the shadow table to identify the records corresponding to the queried interval and processes the records to provide a response to the query. For example, the controller 122A-N or 235 searches the shadow tables 135A-N to identify the records corresponding to the queried interval.

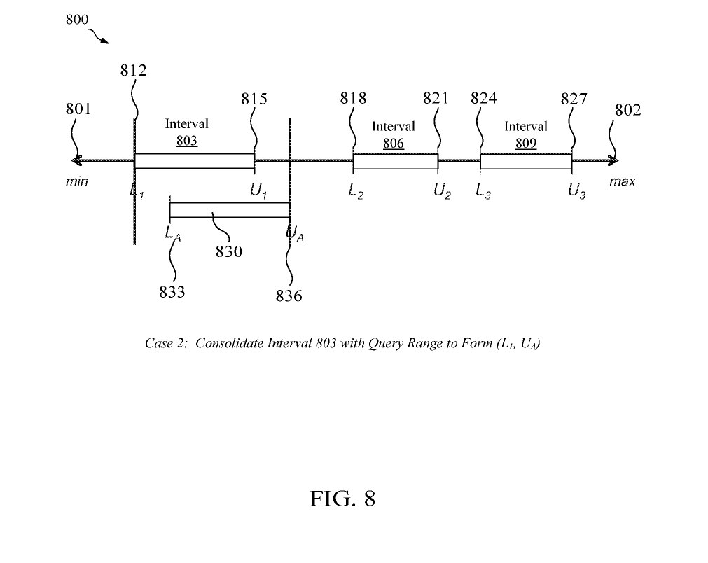

Section 610 of algorithm 600 shows an example of how the database system handles case 2. Case 2 occurs when the database system processes a query for data within a queried interval in which an upper value of the queried interval falls outside of a primary key interval in a shadow table. In other words, case 2 occurs when a shadow table of records does not include one or more records that are necessary to process the query, and the missing records fall on an upper end of the primary key range stored in the shadow table. The intervals in the shadow table and the queried interval are further described in FIG. 8. In this case, the node generates a shadow table for the missing records and then adds the missing records to the shadow table. For example, the controller 122A-N or 235 generates the shadow table for the missing records and then adds the missing records to an already existing shadow table 135A-N for the primary key or row IDs. In one embodiment, an optimizer, such as the optimizer 117 or 230, is configured to remove columns before or after shuffling and before adding the new shuffled records to the existing shadow table. The processing that occurs in case 2 shows how embodiments of the database system can consolidate records to enhance a shadow table.

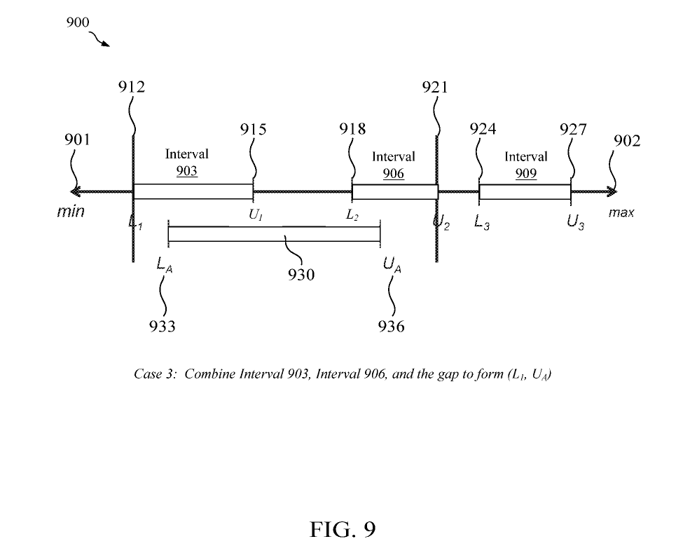

Section 615 of algorithm 600 shows an example of how the database system handles case 3. Case 3 occurs when the database system processes a query for data within a queried interval in which the lower value of the queried interval is covered by a first primary key interval in a shadow table and the upper value of the queried interval is covered by a second primary key interval in the shadow table. The first primary key interval and the second primary key interval have a gap in between in which one or more records of the queried interval are missing. The intervals in the shadow table and the queried interval are further described in FIG. 9. In this case, the node generates a shadow table for the missing records and then adds the missing records to the gap in the shadow table. For example, the controller 122A-N or 235 generates the shadow table for the missing records and then adds the missing records to a gap in an already existing shadow table 135A-N for the primary key or row IDs. In one embodiment, an optimizer, such as the optimizer 117 or 230, is configured to remove columns from the tables before or after shuffling and before adding the new shuffled records to the existing shadow table. The processing that occurs in case 3 also shows how embodiments of the database system can consolidate records to enhance a shadow table.

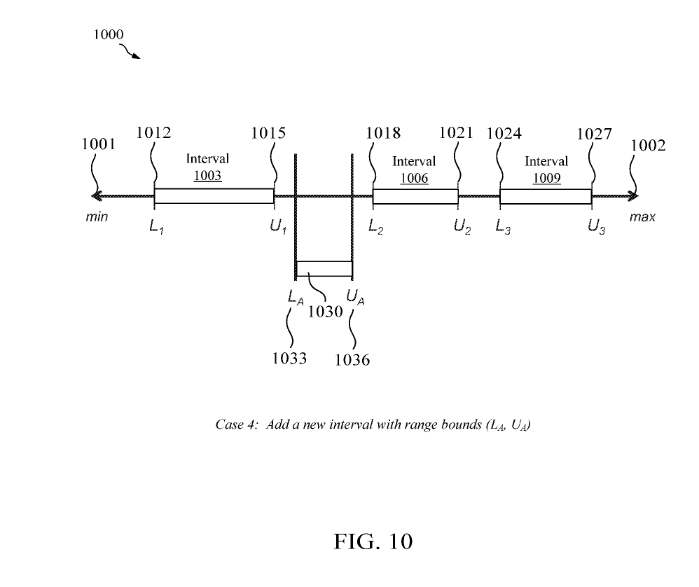

Section 620 of algorithm 600 shows an example of how the database system handles case 4. Case 4 occurs when the database system processes a query for data within a queried interval in which both the lower value and the upper value of the queried interval is not covered by a primary key interval in a shadow table. The intervals in the shadow table and the queried interval are further described in FIG. 10. In this case, the node generates a shadow table for the missing records and then adds the missing records to the shadow table. For example, the controller 122A-N or 235 generates the shadow table for the missing records and then adds the missing records to an already existing shadow table 135A-N for the primary key or row IDs. In one embodiment, an optimizer, such as the optimizer 117 or 230, is configured to remove columns from the records before or after shuffling and before adding the new shuffled records to the existing shadow table. The processing that occurs in case 4 also shows how embodiments of the database system can add new records to enhance a shadow table.

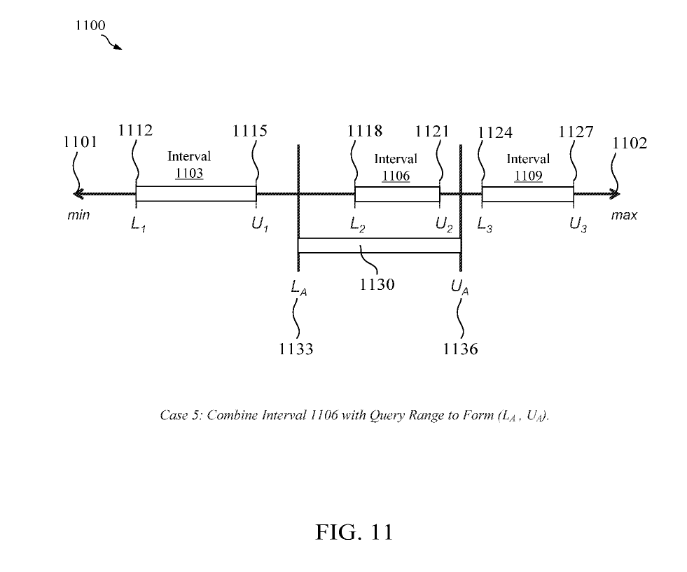

Section 625 of algorithm 600 shows an example of how the database system handles case 5. Case 5 occurs when the database system processes a query for data within a queried interval in which both the lower value and the upper value of the queried interval is not fully covered by a primary key interval in a shadow table. However, unlike case 4, case 5 describes a situation in which a primary key interval in between the lower value and the upper value of the queried interval is covered by the shadow table. In other words, the shadow table includes some records that are relevant to the queried interval; however, there are missing records on either end of the shadow table that may be needed to respond to the request. The intervals in the shadow table and the queried interval are further described in FIG. 11. In this case, the node generates a shadow table for the missing records and then adds the missing records the either end of the shadow table. For example, the controller 122A-N or 235 generates the shadow table for the missing records and then adds the missing records to either end of an already existing shadow table 135A-N for the primary key or row IDs. In one embodiment, an optimizer, such as the optimizer 117 or 230, is configured to remove columns from the records that include irrelevant or unnecessary data before or after shuffling and before adding the new shuffled records to the existing shadow table. The processing that occurs in case 5 also shows how embodiments of the database system can add new records dynamically and according to certain order to enhance a shadow table.

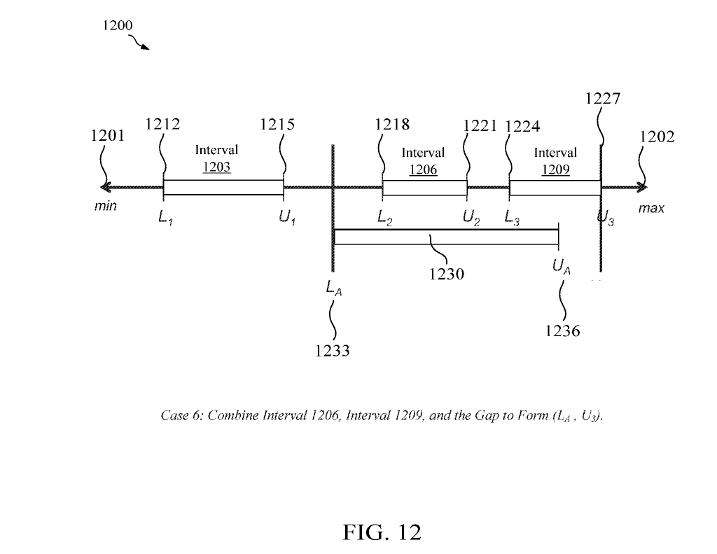

Section 630 of algorithm 600 shows an example of how the database system handles case 6. Case 6 occurs when the database system processes a query for data within a queried interval in which the lower value of the queried interval is not covered by the shadow table, the upper value of the queried interval is covered by a first primary key interval of the shadow table, and there is a primary key interval in the shadow table for an interval in between the lower value and the upper value of the queried interval. In other words, there are two gaps in the primary key intervals of the shadow table that are missing records needed to respond to a query. The intervals in the shadow table and the queried interval are further described in FIG. 12. In this case, the node generates a shadow table for the missing records and then adds the missing records to the gap in the shadow table. For example, the controller 122A-N or 235 generates the shadow table for the missing records and then adds the missing records to an already existing shadow table 135A-N for the primary key or row IDs. In one embodiment, an optimizer, such as the optimizer 117 or 230 is configured to remove columns from the new shuffled records that include irrelevant or unnecessary data before adding the new shuffled records to the existing shadow table. The processing that occurs in case 6 also shows how embodiments of the database system can add new records to enhance a shadow table.

In an embodiment, a query optimizer is configured to instruct the controllers of the nodes to implement a query plan constructed by a parser engine based on a received query. For example, the query optimizer 117 is configured to instruct the controllers 122A-N to implement a query plan constructed by the parser engine 116 based on a received query 400. The query plan may instruct the controller to change the name of a table to be a table copy name when all referenced columns appear in a shadow table and the primary key range is covered by the shadow table.

FIG. 7 is a diagram 700 of an embodiment of storing and updating metadata for a shadow table of records at a node of the database system when the first case occurs. Diagram 700 indicates a minimum 701 and maximum 702 primary key interval that may be provided for a shadow table. The shadow table of records shown in diagram 700 covers three primary key intervals 703, 706, and 709. At a previous time, the shadow table was created by obtaining records associated with the three primary key intervals from database tables partitioned across multiple nodes. The first primary key interval 703 covers a primary key interval lower bound 712 (L₁) to a primary key interval upper bound 715 (U₁). For example, the first primary key interval 703 covers a first range of primary key values that are stored in a shadow table for a primary key. The second primary key interval 706 covers a primary key interval lower bound 718 (L₂) to a primary key interval upper bound 721 (U₂). The second primary key 706 interval covers a second range of primary key values that are stored in the shadow table for the primary key. The third primary key interval 709 covers a primary key interval lower bound 724 (L₃) to a primary key interval upper bound 727 (U₃). The third primary key interval 709 covers a third range of primary key values that are stored in the shadow table for the primary key.

As shown in FIG. 7, the first primary key interval 703, the second primary key interval 706, and the third primary key interval 709 each cover different ranges of primary key values. As an illustrative example, suppose the primary key column is associated with a unit of time, such as years. For example, the primary keys would be years such as 2000, 2001, to 20NN. The primary key intervals for the primary keys are ranges of years. The primary keys for the shadow table is years, and therefore, the common field used to create the shadow table is also years. For example, the first primary key 703 may cover a range of years from 2000 to 2005, the second primary key interval 706 may cover a range of years from 2008 to 2010, and the third primary key interval 709 may cover a range of years from 2012 to 2014. In this way, the shadow table includes records for years 2000 to 2005, 2008 to 2010, and 2012 to 2014, and the metadata reflects that the shadow table includes the records for these primary key intervals. The first primary key interval (2000-2005) is non-contiguous with the second primary key interval (2008-2010) because records between 2006-2007 are not included in the shadow table. The second primary key interval and the third primary key interval are similarly non-contiguous intervals of data.

The queried interval 730 includes a lower value 733 (L_{A}) and upper value 736 (U_{A}) that specify a primary key range that needs to be covered by the shadow table primary key intervals to provide an adequate response to a query. Referring back to the example above, the queried interval 730 may be for records within the years 2002 to 2004, which is already stored at the shadow table in the first primary key interval 703. This first case refers to case 1 described with reference to section 605 of algorithm 600. Case 1 occurs when the database system processes a query for data within a queried interval included in a shadow table stored at the nodes. As shown in FIG. 7, queried interval 730 is fully covered by the primary key interval between primary key interval lower bound 712 (L₁) to a primary key interval upper bound 715 (U₁). Therefore, the node can access the queried interval 730 directly from the shadow table to process the data and provide a response to the query. For example, the controller 122A-N or 235 searches the shadow tables 135A-N to identify the records corresponding to the queried interval 730. In case 1, the shadow table has not been changed, therefore the metadata, such as metadata 119 or 260, that describes the shadow table does not need to be updated.

FIG. 8 is a diagram 800 of an embodiment of storing and updating metadata for a shadow table of records at a node of the database system when the second case occurs. Diagram 800 indicates a minimum 801 and maximum 802 primary key interval that may be provided for a shadow table. The shadow table of records shown in diagram 800 covers three primary key intervals 803, 806, and 809 that are similar to primary key intervals 703, 706, and 709. The first primary key interval 803 covers a primary key interval lower bound 812 (L₁) to a primary key interval upper bound 815 (U₁). The second primary key interval 806 covers a primary key interval lower bound 818 (L₂) to a primary key interval upper bound 821 (U₂). The third primary key interval 809 covers a primary key interval lower bound 824 (L₃) to a primary key interval upper bound 827 (U₃). The queried interval 830 includes a lower value 833 (L_{A}) and upper value 836 (U_{A}) that specify a primary key range that needs to be covered by the shadow table primary key intervals to provide an adequate response to a query. Referring back to the example above, the queried interval 830 may be for records within the years 2002 to 2006. The records from 2002 to 2005 are stored in the first primary key interval 803. However, the records through 2006 are not stored at the shadow table for the primary key interval related to years. Therefore, a shuffle operation may be performed to obtain the records through 2006 from different nodes. This second case refers to case 2 described with reference to section 610 of algorithm 600. Case 2 occurs when the database system processes a query for data within a queried interval 830 in which an upper value 836 (U_{A}) of the queried interval falls outside of a primary key interval 803 in a shadow table. In other words, case 2 occurs when a shadow table of records does not include one or more records that are necessary to process the query, and the missing records fall on an upper end of the primary key range stored in the shadow table.

As shown in FIG. 8, queried interval 830 is not fully covered by any of the primary key intervals 803, 806, or 809. While a portion of primary key interval 803 does cover a portion of the queried interval 830, there are still missing records from primary key interval upper bound 815 (U₁) to upper value 836 (U_{A}) that may be shuffled to be used to respond to the query. The shuffled records may be added to the primary key interval 803. Therefore, the node may generate a shadow table including the missing records from primary key interval upper bound 815 (U₁) to upper value 836 (U_{A}). For example, the controller 122A-N or 235 generates the shadow table for the missing records and then adds the missing records to an already existing shadow table 135A-N for the primary key or row IDs. In case 2, shuffled records are consolidated with the records of the shadow table, and therefore, the node may update the metadata to reflect the consolidation to the primary key intervals of the shadow table. For example, the controller 122A-N updates the metadata 119 or 260 to indicate that the primary key interval upper bound 815 (U₁) for primary key interval 803 is now the upper value 836 (U_{A}).

FIG. 9 is a diagram 900 of an embodiment of storing and updating metadata for a shadow table of records at a node of the database system when the third case occurs. Diagram 900 indicates a minimum 901 and maximum 902 primary key interval that may be provided for a shadow table. The shadow table of records shown in diagram 900 covers three primary key intervals 903, 906, and 909 that are similar to primary key intervals 703, 706, and 709 and primary key intervals 803, 806, and 809. The first primary key interval 903 covers a primary key interval lower bound 912 (L₁) to a primary key interval upper bound 915 (U₁). The second primary key interval 906 covers a primary key interval lower bound 918 (L₂) to a primary key interval upper bound 921 (U₂). The third primary key interval 909 covers a primary key interval lower bound 924 (L₃) to a primary key interval upper bound 927 (U₃). The queried interval 930 includes a lower value 933 (L_{A}) and upper value 936 (U_{A}) that specify a primary key range that needs to be covered by the shadow table primary key intervals to provide an adequate response to a query. Referring back to the example above, the queried interval 930 may be for records within the years 2002 to 2009. The records from 2002 to 2005 are stored in the first primary key interval 903 and the records from 2008 to 2009 are stored in the second primary key interval 906. However, the records between 2005 and 2008 are not stored at the shadow table for the primary key interval related to years. Therefore, a shuffle operation may be performed to obtain the records between 2006 and 2007 from different nodes. This third case refers to case 3 described with reference to section 615 of algorithm 600. Case 3 occurs when the database system processes a query for data within a queried interval 930 in which the lower value of the queried interval 933 is covered by a first primary key interval 903 in a shadow table and the upper value of the queried interval 936 (U_{A}) is covered by a second primary key interval 906 in the shadow table. There is a gap between primary key interval upper bound 915 (U₁) and primary key interval lower bound 918 (L₂) in which one or more records that are queried are missing.

As shown in FIG. 9, queried interval 930 is not fully covered by any of the primary key intervals 903, 906, or 909. While a portion of primary key interval 903 and a portion of primary key interval 906 does cover a portion of the queried interval 930, there are still missing records from primary key interval upper bound 915 (U₁) to primary key interval lower bound 918 (L₂) that may be shuffled to be used to respond to the query. The shuffled records may be added to the shadow table to fill in the gap between primary key interval upper bound 915 (U₁) and primary key interval lower bound 918 (L₂). Therefore, the node may generate a shadow table including the missing records from primary key interval upper bound 915 (U₁) and primary key interval lower bound 918 (L₂). For example, the controller 122A-N or 235 generates the shadow table for the missing records and then adds the missing records to an already existing shadow table 135A-N for the primary key or row IDs. In case 3, shuffled records are consolidated with the records of the shadow table, and therefore, the node may update the metadata to reflect the consolidation to the primary key intervals of the shadow table. For example, the controller 122A-N may update the metadata 119 or 260 to indicate that the primary key interval 903 and primary key interval 906 have merged to cover an interval from primary key interval lower bound 912 (L₁) to primary key interval upper bound 921 (U₂).

FIG. 10 is a diagram 1000 of an embodiment of storing and updating metadata for a shadow table of records at a node of the database system when the fourth case occurs. Diagram 1000 indicates a minimum 1001 and maximum 1002 primary key interval that may be provided for a shadow table. The shadow table of records shown in diagram 1000 covers three primary key intervals 1003, 1006, and 1009 that are similar to primary key intervals 703, 706, and 709, primary key intervals 803, 806, and 809, and primary key intervals 903, 906, and 909. The first primary key interval 1003 covers a primary key interval lower bound 1012 (L₁) to a primary key interval upper bound 1015 (U₁). The second primary key interval 1006 covers a primary key interval lower bound 1018 (L₂) to a primary key interval upper bound 1021 (U₂). The third primary key interval 1009 covers a primary key interval lower bound 1024 (L₃) to a primary key interval upper bound 1027 (U₃). The queried interval 1030 includes a lower value 1033 (L_{A}) and upper value 1036 (U_{A}) that specify a primary key range that needs to be covered by the shadow table primary key intervals to provide an adequate response to a query. Referring back to the example above, the queried interval 1030 may be for records within the years 2006 to 2007. However, the records between 2006 and 2007 are not stored at the shadow table for the primary key interval related to years. Therefore, a shuffle operation may be performed to obtain the records between 2006 and 2007 from different nodes. This fourth case refers to case 4 described with reference to section 620 of algorithm 600. Case 4 occurs when the database system processes a query for data within a queried interval 1030 in which both the lower value 1033 (L_{A}) and the upper value 1036 (U_{A}) of the queried interval 130 is not covered by a primary key interval in a shadow table.

As shown in FIG. 10, queried interval 1030 is not fully covered by any of the primary key intervals 1003, 1006, or 1009. None of primary key interval 1003, primary key interval 1006, or primary key interval 1009 includes any of the records that are in the queried interval 1030. The shuffled records may be added to the shadow table between the lower value 1033 (L_{A}) and the upper value 1036 (U_{A}). Therefore, the node may add the new records to an existing shadow table including the missing records from the lower value 1033 (L_{A}) and the upper value 1036 (U_{A}). For example, the controller 122A-N or 235 adds the missing records to an already existing shadow table 135A-N for the primary key or row IDs. In case 4, shuffled records are added as a new primary key interval to be included with the records of the shadow table, and therefore, the node may update the metadata to reflect the new primary key of the shadow table. For example, the controller 122A-N may update the metadata 119 or 260 to indicate that the new primary key interval from the lower value 1033 (L_{A}) and the upper value 1036 (U_{A}).

FIG. 11 is a diagram 1100 of an embodiment of storing and updating metadata for a shadow table of records at a node of the database system when the fifth case occurs. Diagram 1100 indicates a minimum 1101 and maximum 1102 primary key interval that may be provided for a shadow table. The shadow table of records shown in diagram 1100 covers three primary key intervals 1103, 1106, and 1109 that are similar to primary key intervals 703, 706, and 709, primary key intervals 803, 806, and 809, primary key intervals 903, 906, and 909, and primary key intervals 1003, 1006, and 1006. The first primary key interval 1103 covers a primary key interval lower bound 1112 (L₁) to a primary key interval upper bound 1115 (U₁). The second primary key interval 1106 covers a primary key interval lower bound 1118 (L₂) to a primary key interval upper bound 1121 (U₂). The third primary key interval 1109 covers a primary key interval lower bound 1124 (L₃) to a primary key interval upper bound 1127 (U₃). The queried interval 1130 includes a lower value 1133 (L_{A}) and upper value 1136 (U_{A}) that specify a primary key range that needs to be covered by the shadow table primary key intervals to provide an adequate response to a query. Referring back to the example above, the queried interval 1130 may be for records within the years 2006 to 2011. The records from 2008 to 2010 are stored in the second primary key interval 1106. However, the records between 2006 and 2007 are not stored at the shadow table for the primary key interval related to years. The records in 2011 are also not stored at the shadow table for the primary key interval related to years. Therefore, a shuffle operation may be performed to obtain the records between 2006 and 2007 and the records 2011 from different nodes. This fifth case refers to case 5 described with reference to section 625 of algorithm 600. Case 5 occurs when the database system processes a query for data within a queried interval 1130 in which both the lower value 1133 (L_{A}) and the upper value 1136 (U_{A}) of the queried interval 1130 are not fully covered by a primary key interval 1103, 1106, or 1109 in a shadow table. However, unlike case 4, case 5 describes a situation in which a primary key interval 1106 in between the lower value 1133 (L_{A}) and the upper value 1136 (U_{A}) of the queried interval 1130 is covered by the shadow table.

As shown in FIG. 11, queried interval 1130 is not fully covered by any of the primary key intervals 1103, 1106, or 1109. While the entire primary key interval 1106 is covered by the queried interval 1130, there are still missing records in the queried interval from lower value 1133 (L_{A}) to primary key interval lower bound 1118 (L₂) and primary key interval upper bound 1121 (U₂) to upper value 1136 (U_{A}) that may be shuffled to be used to respond to the query. The shuffled records may be added to the shadow table to fill in the gaps between lower value 1133 (L_{A}) to primary key interval lower bound 1118 (L₂) and between primary key interval upper bound 1121 (U₂) to upper value 1136 (U_{A}). Therefore, the node may generate a shadow table including the missing records between lower value 1133 (L_{A}) to primary key interval lower bound 1118 (L₂) and between primary key interval upper bound 1121 (U₂) to upper value 1136 (U_{A}). For example, the controller 122A-N or 235 generates the shadow table for the missing records and then adds the missing records to an already existing shadow table 135A-N for the primary key or row IDs. In case 5, shuffled records are consolidated with the records of the shadow table, and therefore, the node may update the metadata to reflect the consolidation to the primary key intervals of the shadow table. For example, the controller 122A-N may update the metadata 119 or 260 to indicate that the primary key interval 1106 now covers from lower value 1133 (L_{A}) to upper value 1136 (U_{A}).

FIG. 12 is a diagram 1200 of an embodiment of storing and updating metadata for a shadow table of records at a node of the database system when the sixth case occurs. Diagram 1200 indicates a minimum 1201 and maximum 1202 primary key interval that may be provided for a shadow table. The shadow table of records shown in diagram 1200 covers three primary key intervals 1203, 1206, and 1209 that are similar to primary key intervals 703, 706, and 709, primary key intervals 803, 806, and 809, primary key intervals 903, 906, and 909, primary key intervals 1003, 1006, and 1006, and primary key intervals 1103, 1106, and 1109. The first primary key interval 1203 covers a primary key interval lower bound 1212 (L₁) to a primary key interval upper bound 1215 (U₁). The second primary key interval 1206 covers a primary key interval lower bound 1218 (L₂) to a primary key interval upper bound 1221 (U₂). The third primary key interval 1209 covers a primary key interval lower bound 1224 (L₃) to a primary key interval upper bound 1227 (U₃). The queried interval 1230 includes a lower value 1233 (L_{A}) and upper value 1236 (U_{A}) that specify a primary key range that needs to be covered by the shadow table primary key intervals to provide an adequate response to a query. Referring back to the example above, the queried interval 1230 may be for records within the years 2006 to 2013. The records from 2008 to 2010 are stored in the second primary key interval 1206 and the records from 2012 to 2014 are stored in the third primary key interval 1209. However, the records between 2006 and 2007 are not stored at the shadow table for the primary key interval related to years. The records between 2010 and 2011 are also not stored at the shadow table for the primary key interval related to years. Therefore, a shuffle operation may be performed to obtain the records between 2006 and 2007 and the records between 2010 and 2011 from different nodes. The sixth case refers to case 6 described with reference to section 630 of algorithm 600. Case 6 occurs when the database system processes a query for data within a queried interval 1230 in which the lower value 1233 (L_{A}) of the queried interval 1230 is not covered by the shadow table. The upper value 1236 (U_{A}) of the queried interval 1230 is covered by a primary key interval 1209 of the shadow table, and there is a primary key interval 1206 in the shadow table for an interval in between the lower value 1233 (L_{A}) and the upper value 1236 (U_{A}) of the queried interval 1230. In other words, there are two gaps in the primary key intervals of the shadow table that are missing records that may needed to respond to a query.

As shown in FIG. 12, queried interval 1230 is not fully covered by any of the primary key intervals 1203, 1206, or 1209. While the entire primary key interval 1206 and a portion of the primary key interval 1209 is covered by the queried interval 1230, there are still missing records in the queried interval from lower value 1233 (L_{A}) to primary key interval lower bound 1218 (L₂) and primary key interval upper bound 1221 (U₂) to primary key interval lower bound 1224 (L₃) that may be shuffled to be used to respond to the query. The shuffled records may be added to the shadow table to fill in the gaps between lower value 1233 (L_{A}) to primary key interval lower bound 1218 (L₂) and between primary key interval upper bound 1221 (U₂) to primary key interval lower bound 1224 (L₃). Therefore, the node may generate a shadow table including the missing records between lower value 1233 (L_{A}) to primary key interval lower bound 1218 (L₂) and between primary key interval upper bound 1221 (U₂) to primary key interval lower bound 1224 (L₃). For example, the controller 122A-N or 235 generates the shadow table for the missing records and then adds the missing records to an already existing shadow table 135A-N for the primary key or row IDs. In case 6, shuffled records are consolidated with the records of the shadow table, and therefore, the node may update the metadata to reflect the consolidation to the primary key intervals of the shadow table. For example, the controller 122A-N may update the metadata 119 or 260 to indicate that the primary key intervals 1206 and 1209 have updated and expanded to be from lower value 1233 (L_{A}) to primary key interval upper bound 1227 (U₃).

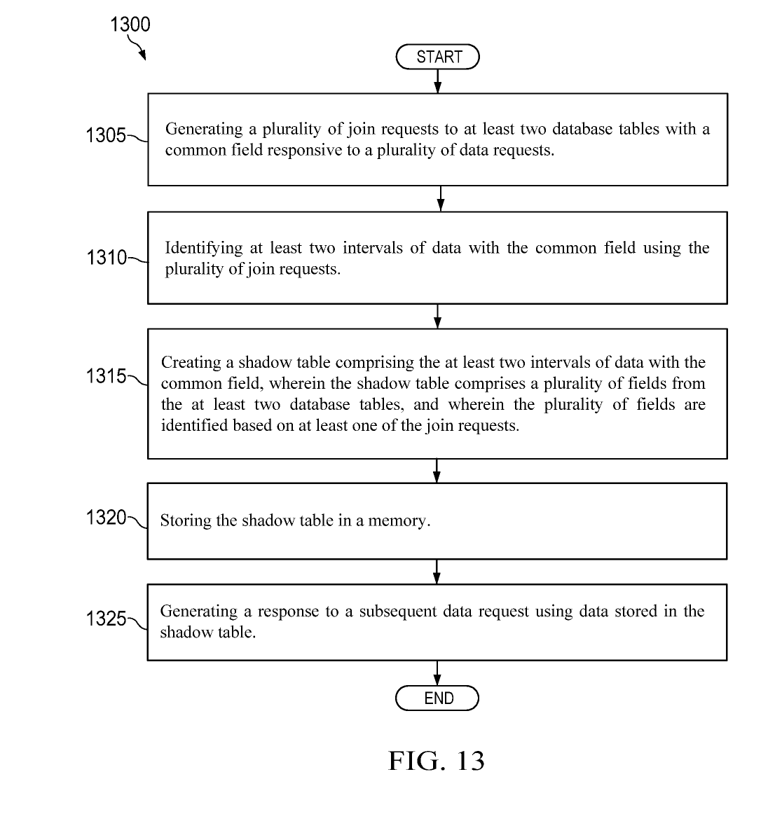

FIG. 13 is a flowchart an embodiment of a method of storing and updating a shadow table of records. The method 1300 is implemented by a database system, such as the database system 105, or an NE, such as the NE 200, in a database network, such as the database network 100. The method 1300 begins when a data request from a client is received. At step 1305, a plurality of join requests to at least two database tables with a common field are generated responsive to a plurality of data requests. For example, the controllers 122A-N or the processor 205 generates a plurality of join requests to at least two database tables with a common field responsive to a plurality of data requests. For example, the data request is similar to the query 400. The at least two database tables are similar to the customer table 300 and the orders table 350. The common field is the join columns c_custkey and o_custkey in customer table 300 and orders table 350 respectively.

At step 1310, at least two intervals of data with the common field using the plurality of join requests. For example, the controllers 122A-N or the processor 205 identifies at least two intervals of data with the common field using the plurality of join requests. For example, if the data request is for data within a certain time frame, the common field may be years, and the intervals of data may be associated with different non-consecutive years. At step 1315, a shadow table comprising the at least two intervals of data with the common field is generated. For example, the controllers 122A-N or the processor 205 generates the shadow table. In an embodiment, the shadow table comprises a plurality of fields from the at least two database tables. In an embodiment, and wherein the plurality of fields are identified based on at least one of the join requests. For example, the shadow table is generated to include other fields, or columns, that include other data as specified by the data request. At step 1320, the shadow table is stored in a memory, such as memory 250 in shadow tables 255. At step 1325, a response to a subsequent data request is generated using data stored in the shadow table instead having to shuffle the same records again to respond to the data request. For example, the controllers 122A-N or the processor 205 generates the response to the subsequent data request using data stored in the shadow table. In an embodiment, the response to the subsequent data request is transmitted to the client using Tx/Rx 210.

As described above, saving a shadow table for each primary key column speeds up the shuffled join queries by avoiding having to perform a data shuffle at run time each time a query is received for records having the primary key. The shadow tables disclosed herein do not contain unnecessary or irrelevant data items. For example, shadow tables are not built with data ranges that are not accessed.

In an embodiment, the disclosure includes a method implemented by a database system, comprising a means for generating a plurality of join requests to at least two database tables with a common field responsive to a plurality of data requests, a means for identifying at least two intervals of data with the common field using the plurality of join requests, a means for creating a shadow table comprising the at least two intervals of data with the common field, wherein the shadow table comprises a plurality of fields from the at least two database tables, and wherein the plurality of fields are identified based on at least one of the join requests, a means for storing the shadow table, and a means for generating a response to a subsequent data request using data stored in the shadow table.

In an embodiment, the disclosure includes a database system comprising a means for generating a plurality of join requests to at least two database tables with a common field responsive to a plurality of data requests, a means for identifying at least two intervals of data with the common field using the plurality of join requests, a means for creating a shadow table comprising the at least two intervals of data with the common field, wherein the shadow table comprises a plurality of fields from the at least two database tables, wherein the plurality of fields are identified based on at least one of the join requests, a means for storing the shadow table, and a means for generating a response to a subsequent data request using data stored in the shadow table.

In an embodiment, the disclosure includes a means for generating a plurality of join requests to at least two database tables with a common field responsive to a plurality of data requests, a means for identifying at least two intervals of data with the common field using the plurality of join requests, a means for a shadow table comprising the at least two intervals of data with the common field, wherein the shadow table comprises a plurality of fields from the at least two database tables, wherein the plurality of fields are identified based on at least one of the join requests, and a means for generating a response to a subsequent data request using data stored in the shadow table.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented by a database system, comprising:
generating, by a processor of the database system, a plurality of join requests to at least two database tables with a common field responsive to a plurality of data requests;
identifying, by the processor, at least two intervals of data with the common field using the plurality of join requests;
creating, by the processor, a shadow table comprising the at least two intervals of data with the common field, wherein the shadow table comprises a plurality of fields from the at least two database tables, and wherein the plurality of fields are identified based on at least one of the join requests;
storing, by a memory coupled to the processor, the shadow table; and
generating, by the processor, a response to a subsequent data request using data stored in the shadow table.

2. The method of claim 1, wherein the common field is a column in each of the at least two database tables that includes a common type of data.

3. The method of claim 1, wherein the plurality of fields included in the shadow table is selected based on at least one type of data indicated in at least one of the data requests.

4. The method of claim 1, wherein the at least two intervals of the common field comprise a first interval and a second interval, and wherein the first interval and the second interval are non-contiguous.

5. The method of claim 1, further comprising:
identifying, by the processor, cold data within the shadow table; and
removing, by the processor, the cold data from the shadow table.

6. The method of claim 1, wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields.

7. The method of claim 1, further comprising updating, by the processor, the shadow table to further comprise a next interval of data with the common field responsive to another subsequent data request.

8. The method of claim 1, further comprising transmitting, by a transmitter coupled to the processor, metadata describing the at least two intervals and the fields of the shadow table to a master network element, wherein the master network element maintains a metadata table describing the shadow table stored at the network element.

9. The method of claim 1, wherein the at least two intervals of data are stored across a plurality of other network elements and across the at least two database tables.

10. A database system, comprising:
a memory; and
a processor coupled to the memory and configured to:
generate a plurality of join requests to at least two database tables with a common field responsive to a plurality of data requests;
identify at least two intervals of data with the common field using the plurality of join requests;
create a shadow table comprising the at least two intervals of data with the common field, wherein the shadow table comprises a plurality of fields from the at least two database tables, wherein the plurality of fields are identified based on at least one of the join requests, and wherein the memory is configured to store the shadow table; and
generate a response to a subsequent data request using data stored in the shadow table.

11. The database system of claim 10, wherein the common field is a column in each of the at least two database tables that includes a common type of data.

12. The database system of claim 10, wherein the fields included in the shadow table are selected based on at least one type of data indicated in at least one of the data requests.

13. The database system of claim 10, wherein the processor is further configured remove cold data from the shadow table.

14. The database system of claim 10, wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields.

15. An apparatus, comprising:
a memory; and
a processor coupled to the memory and configured to:
generate a plurality of join requests to at least two database tables with a common field responsive to a plurality of data requests;
identify at least two intervals of data with the common field using the plurality of join requests;
create a shadow table comprising the at least two intervals of data with the common field, wherein the shadow table comprises a plurality of fields from the at least two database tables, wherein the plurality of fields are identified based on at least one of the join requests, and wherein the memory is configured to store the shadow table; and
generate a response to a subsequent data request using data stored in the shadow table.

16. The apparatus of claim 15, further comprising a transmitter coupled to the processor and configured to transmit metadata describing the at least two intervals and the fields of the shadow table to a master network element, wherein the master network element maintains a metadata table describing the shadow table stored at the network element.

17. The apparatus of claim 15, wherein the at least two intervals of the common field comprises a first interval and a second interval, wherein the first interval comprises a plurality of first records, wherein the second interval comprises a plurality of second records, wherein the first records include a plurality of first fields selected based on a first one of the join requests, wherein the second records include a plurality of second fields selected based on a second one of the join requests, and wherein the fields comprising the first fields and the second fields.

18. The apparatus of claim 1, wherein the processor is further configured to update the shadow table to further comprise a next interval of data with the common field responsive to another subsequent join request.

19. The apparatus of claim 15, wherein the at least two intervals of data are stored across a plurality of other network elements and across the at least two database tables.

20. The apparatus of claim 15, wherein the common field is a column in each of the at least two database tables that includes a common type of data, and wherein the fields included in the shadow table are selected based on at least one type of data indicated in at least one of the data requests.
